(19) United States
(12) Patent Application Publication
(10) Pub. No.: US 2010/0062222 A1
(43) Pub. Date: Mar. 11, 2010

(54) DIE MANUFACTURING METHOD, FUNCTIONAL FILM MANUFACTURING METHOD AND FUNCTIONAL FILM

(75) Inventors: Hidehisa Murase, Kanagawa (JP); Yoshinari Sasaki, Tokyo (JP); Kosei Aso, Kanagawa (JP); Tomohide Jozaki, Kanagawa (JP); Setsuo Okino, Tokyo (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: SONY CORPORATION, Tokyo (JP)

(21) Appl. No.: 12/552,473

(22) Filed: Sep. 2, 2009

(30) Foreign Application Priority Data
Sep. 8, 2008 (JP) 2008-229362

(51) Int. Cl. C25D 1/10; B29C 59/02; B29C 59/16; B32B 3/00

(52) U.S. Cl. 428/156; 205/70; 264/293

(57) ABSTRACT

Disclosed herein is a die manufacturing method including the steps of: forming a pattern on the machining surface of a cylindrical resin original plate by laser machining; and fabricating a cylindrical die by the electroforming method using the resin original plate having the pattern formed.

### BACKGROUND OF THE INVENTION

1. Field of the Invention

The present invention relates to a die manufacturing method, functional film manufacturing method and functional film.

2. Description of the Related Art

The reduction in thickness of television sets (hereinafter also written as “TVs”) in recent years has been amazing, with the manufacturers competing fiercely to develop flat panel displays such as liquid crystal, plasma and organic EL (Electro Luminescence) TVs. Of all these, liquid crystal TVs enjoy popularity for their ease of manufacture, excellent image quality and manageable price range, thus occupying a commanding position in terms of number of units sold. On the other hand, liquid crystal panels are finding extremely wide application in mobile equipment including laptop PCs (Personal Computers) and mobile phones, with the manufacturers vying with each other to achieve cost reduction and differentiate the performance.

Liquid crystal panels use a number of optical functional films to bring out their optical properties. Among optical functional films are polarizing film, prism sheet, optical diffusion film, phase difference film and reflection film. One of the techniques for manufacturing such optical functional films uses the roll-to-roll transfer system which shapes the film base material (transfers a pattern) while winding it onto a roll.

FIG. 8 is a diagrammatic view illustrating a configuration of a film manufacturing apparatus based on the roll-to-roll transfer system. In FIG. 8, a section called a die coater 51 discharges transparent film base material 52. The discharged film base material 52 is wound onto a cylindrical die 53 and carried in one direction, thus allowing a pattern to be transferred from the die 53 to the film base material 52. A pattern of projections and depressions adapted to provide the film with predetermined optical properties is formed on the outer peripheral surface of the die 53. A transfer roll 54 and feed roll 55 are provided, one on each side of the die 53 in such a manner as to sandwich the die 53 from left and right. The transfer roll 54 and feed roll 55 are each pressed against the die 53 with a predetermined pressure.

The transfer roll 54 transfers the pattern of the die 53 onto the film base material 52 as it rotates in synchronism with the die 53 with the film base material 52 pinched between this roll and die 53. During the transfer, the transfer roll 54 heats the film base material 52 as occasion demands. The feed roll 55 delivers the film base material 52 as it rotates with the film base material 52 pinched between this roll and die 53. During the delivery, the feed roll 55 cools the film base material 52 as occasion demands.

The above cylindrical die 53 used for manufacturing optical functional films is fabricated by the following method. That is, a die in the form of a flat plate having a pattern of projections and depressions is fabricated first. Next, the die in the form of a flat plate is rounded into a tubular, cylindrical form.

If the die 53 is fabricated by the method as described above, a seam remains on the outer peripheral surface of the die 53. Therefore, when an optical functional film is manufactured, undesired portions which cannot be used as an optical functional film are produced because of the seam each time the die 53 rotates one turn. When liquid crystal panels were used primarily for laptop PCs, it was only necessary to dispose of the above undesired portions produced during the film manufacturing process because of the small panel size used for the PCs. However, with rapidly increasing panel size as a result of application of liquid crystal panels to TVs, a film of a size required for one liquid crystal panel can be produced only if the die 53 is rotated more than one turn. This has made the film disposal unavailable as a choice, thus demanding a seamless die.

### (Disclosure of Related Art Literature)

Japanese Patent Laid-Open No. 2005-125359 discloses a technique for forming grooves on an inner surface of a work by irradiating a CO₂ or YAG laser beam approximately perpendicularly onto the inner surface thereof. Japanese Patent Laid-Open No. Hei 11-170472 relates to the manufacturing of a gravure cylinder. This Patent Document discloses a technique for forming depressions as cells to be filled with ink by irradiating a laser beam from the inner surface of a cylindrical member made of reinforced glass and focusing the laser beam onto the outer peripheral surface of the cylindrical member.

### SUMMARY OF THE INVENTION

In order to fabricate a die for manufacturing functional films in a seamless manner, it is common to directly machine a cylindrical die material (metallic material) with a cutting machine. In recent years, die materials in excess of 1 m in diameter are coming into use from the viewpoint of productivity as increasing in size of panels. This has resulted in the cutting taking more than 24 hours and extending to as long as a few days. On the other hand, in order to achieve continuous machining in a stable manner for extended periods, it is essential to extend the service life of diamond bite. Further, it is necessary to perform machining on an isolated special ground to ensure that no external vibrations are transferred during the machining. Still further, complicated machined shapes have become necessary to provide improved optical properties of films, and some shapes currently in demand cannot be achieved by machining.

A die manufacturing method according to an embodiment of the present invention includes a step of forming a pattern on the machining surface of a cylindrical resin original plate by laser machining. The die manufacturing method also includes a step of fabricating a cylindrical die by the electroforming method using the resin original plate having the pattern formed.

The die manufacturing method according to the embodiment of the present invention allows for the formation of a seamless pattern of desired shape on the machining surface of a cylindrical resin original plate by means of laser machining. Further, the electroforming process using the resin original plate having the pattern formed thereon makes it possible to copy the pattern formed on the machining surface of the resin original plate in an “as-is” form or with the projections and depressions inverted from the original pattern.

A functional film manufacturing method according to the embodiment of the present invention includes a step of transferring a pattern of a die obtained by a die manufacturing method onto a film base material by using the die. The die manufacturing method includes a step of forming a pattern on the machining surface of a cylindrical resin original plate by laser machining. The die manufacturing method also includes a step of fabricating a cylindrical die by the electroforming method using the resin original plate having the pattern formed.

The functional film manufacturing method according to the embodiment of the present invention eliminates the likelihood of undesired portions being produced due to the presence of a seam by transferring a pattern of a die obtained by the die manufacturing method onto a film base material by using the die.

A functional film according to the embodiment of the present invention is obtained by transferring a pattern of a die obtained by a die manufacturing method onto a film base material by using the die. The die manufacturing method includes a step of forming a pattern on the machining surface of a cylindrical resin original plate by laser machining. The die manufacturing method also includes a step of fabricating a cylindrical die by the electroforming method using the resin original plate having the pattern formed.

The functional film according to the embodiment of the present invention is obtained by transferring a pattern of a die obtained by the die manufacturing method onto a film base material by using the die, thus eliminating the likelihood of undesired portions being produced due to the presence of a seam.

The die manufacturing method according to the embodiment of the present invention allows for the fabrication of a cylindrical die for use in the manufacture of functional films in a seamless manner without cutting a cylindrical die material. The die manufacturing method also allows for the formation of a pattern of a desired shape on a resin original plate, thus making it possible to fabricate a cylindrical die having a free curved surface.

The functional film manufacturing method according to the embodiment of the present invention allows for the manufacture of functional films having uniform properties without producing undesired portions resulting from the presence of a seam.

The functional film according to the embodiment of the present invention provides a functional film free from undesired portions resulting from the presence of a seam and having uniform properties.

### BRIEF DESCRIPTION OF THE DRAWINGS

FIG. 1 is a diagrammatic view illustrating a configuration of a laser machining apparatus used for a die manufacturing method according to an embodiment of the present invention;

FIG. 2 is a diagrammatic view illustrating major parts of the laser machining apparatus used for the die manufacturing method according to the embodiment of the present invention;

FIG. 3 is a schematic view describing an example of a pattern forming method by means of laser machining;

FIGS. 4A to 4E are diagrams describing an example of a die manufacturing process according to the embodiment of the present invention;

FIGS. 5A and 5B are diagrams describing an example of a pattern shape of a die obtained by the die manufacturing method according to the embodiment of the present invention;

FIG. 6 is a diagrammatic view illustrating another configuration of the laser machining apparatus used for the die manufacturing method according to the embodiment of the present invention;

FIGS. 7A to 7C are diagrams describing another example of the die manufacturing process according to the embodiment of the present invention; and

FIG. 8 is a diagrammatic view illustrating a configuration of a film manufacturing apparatus based on the roll-to-roll transfer system.

### DETAILED DESCRIPTION OF THE PREFERRED EMBODIMENTS

A detailed description will be given below of specific embodiments of the present invention with reference to the accompanying drawings. It should be noted that the technical scope of the present invention is not limited to the embodiment described below, but includes embodiments having various alterations or modifications as long as specific effects are derivable which can be obtained by the constituent features of the present invention or a combination thereof.

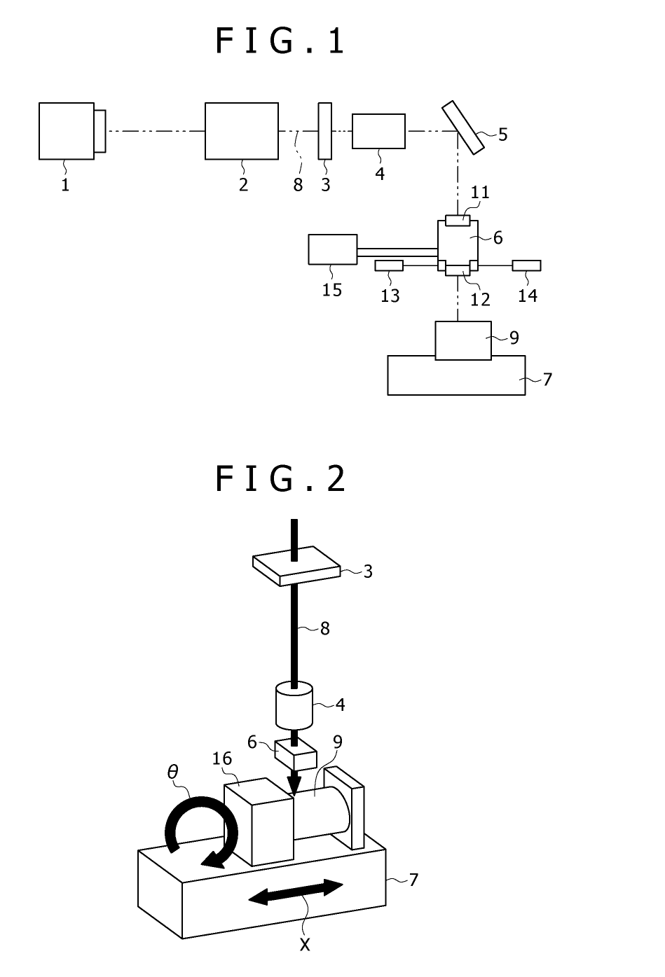

FIG. 1 is a diagrammatic view illustrating a configuration of a laser machining apparatus used for the die manufacturing method according to an embodiment of the present invention. FIG. 2 is a diagrammatic view illustrating major parts of the laser machining apparatus. The laser machining apparatus shown in FIGS. 1 and 2 primarily includes a laser beam source 1, beam shaper 2, mask (or variable aperture) 3, projection lens 4, reflecting mirror 5, debris collection mechanism 6 and stage 7. These constituent elements (1, 2, 3, 4, 5, 6 and 7) are arranged in order from the upstream to downstream sides of a laser optical path 8. It should be noted that, in FIG. 2 for reasons of convenience, the reflecting mirror 5 is omitted, and the laser optical path 8 is drawn to extend in the vertical direction, with the mask 3 and projection lens 4 shown halfway along the length of the laser optical path 8.

The laser beam source 1 generates a laser beam. For example, an excimer laser should preferably be used as the laser beam source 1. There are a plurality of types of excimer lasers with different laser media. These excimer lasers are XeF (351 nm), XeCl (308 nm), KrF (248 nm), ArF (193 nm) and F2 (157 nm) in descending order of wavelength. It should be noted that the laser beam source 1 is not limited to an excimer laser, but may be a laser having second to fourth harmonics of a solid-state laser.

The beam shaper 2 shapes the laser beam from the laser beam source 1 into a beam of a predetermined shape (e.g., rectangular) having a uniform intensity distribution. A homogenizer may be used as the beam shaper 2 if an excimer laser is used as the laser beam source 1.

The mask 3 has an opening pattern adapted to pass the laser beam from the beam shaper 2. A perforated mask, photomask, dielectric mask or other mask may be used as the mask 3. A perforated mask is made of a metallic material. A photomask is made of a transparent glass material or metallic thin film. A dielectric mask is made of a dielectric material.

The projection lens 4 projects the laser beam, which has passed through the opening pattern of the mask 3, onto the machining surface of a resin original plate 9 on the stage 7 via the reflecting mirror 5 and debris collection mechanism 6 at a predetermined magnification. The resin original plate 9 is the target to be machined by laser machining.

The reflecting mirror 5 totally reflects the laser beam from the projection lens 4 in such a manner as to bend the optical path thereof at a right angle. It should be noted that the reflecting mirror 5 is used to bend the laser optical path 8 halfway along its length. If there is no need to bend the laser optical path 8 because of the configuration of the laser machining apparatus, the reflecting mirror 5 need not be provided halfway along the length of the laser optical path 8.

The debris collection mechanism 6 collects a reaction product called “debris” which is generated during irradiation of a laser beam onto the machining surface of the resin original plate 9 in such a manner as not to allow it to redeposit on the resin original plate 9. Transmission windows 11 and 12 are provided respectively on the upper and lower portions of the debris collection mechanism 6. The transmission windows 11 and 12 are window members adapted to pass the laser beam reflected by the reflecting mirror 5. Further, gas introduction sections 13 and 14 are connected to the bottom portion of the debris collection mechanism 6. The gas introduction sections 13 and 14 introduce an inert gas such as argon into the space facing the machining surface of the resin original plate 9 (surface onto which the laser beam is irradiated) through a plurality of gas introduction holes (not shown) provided on the bottom portion of the debris collection mechanism 6.

Further, an exhaust pump 15 is connected to the debris collection mechanism 6. A roughing pump, for example, is used as the exhaust pump 15. The exhaust pump 15 exhausts air through a plurality of exhaust holes provided on the bottom portion of the debris collection mechanism 6 in a concentric relationship with the plurality of gas introduction holes, thus turning the space facing the machining surface of the resin original plate 9 into a reduced pressure atmosphere of not more than one atmospheric pressure. As a result, when an inert gas is introduced from the gas introduction sections 13 and 14, a flow of the inert gas, i.e., a gas flow, occurs because of the difference in atmospheric pressure taking place within the space into which the gas has been introduced, thus causing the gas to be sucked into the exhaust holes along the machining surface of the resin original plate 9. This permits the vaporized debris generated during laser machining of the resin original plate 9 to be exhausted and collected by means of the inert gas flow.

The stage 7 is disposed at a predetermined optical distance from the projection lens 4 so that the laser beam projected by the projection lens 4 focuses on the machining surface of the resin original plate 9. The stage 7 is provided in such a manner as to move linearly in the X direction along the plane vertical to the optical axis of the laser beam so that the laser beam can scan the machining surface of the resin original plate 9. A rotating mechanism 16 is provided on the stage 7. The resin original plate 9 is rotatably supported in the θ direction by the rotating mechanism 16. The rotating mechanism 16 is rotated by a precision motor as is done with an air spindle. The rotating mechanism 16 rotatably supports the resin original plate 9 using the end face portion of the same plate 9.

The resin original plate 9 is an original plate made of resin formed in a cylindrical shape. Polyimide, polycarbonate or acryl can be used, for example, as the material of the resin original plate 9. The laser beam used to machine the same plate 9 should preferably have a wavelength in the ultraviolet region. The reason for this is that a laser beam having a wavelength in the ultraviolet region is more readily absorbed by resin materials than a laser beam having a wavelength in the infrared region.

The laser machining apparatus configured as described above is used in the patterning process adapted to form a pattern on the resin original plate 9. In the patterning process, the resin original plate 9 is first placed on the stage 7. At this time, the resin original plate 9 is positioned on the stage 7 and attached to the rotating mechanism 16 so that the central axis of the cylindrical resin original plate 9 is coaxial with the rotation axis of the rotating mechanism 16 and so that the central axis of the same plate 9 is parallel to a travel direction X of the stage 7.

Next, a laser beam is emitted from the laser beam source 1 and irradiated onto the outer peripheral surface (machining surface) of the resin original plate 9, thereby forming a pattern of projections and depressions. If the outer peripheral surface (machining surface) of the resin original plate 9 is to be machined, the projection lens 4 can be disposed near the machining surface. As a result, a short focal distance lens can be adopted. This permits laser machining to be performed at a high resolution. This also permits easy collection of debris using the debris collection mechanism 6. If the resin original plate 9 is machined with a laser beam, it is preferred to use a laser beam having a wavelength in the ultraviolet region which can be readily absorbed by the resin material of which the resin original plate 9 is made as described earlier. If a laser beam having a wavelength in the ultraviolet region is used, etching can be performed using a method called “laser abrasion.” Laser abrasion breaks the molecular bond by means of high photon energy. Patterning of the resin original plate 9 using laser abrasion allows for accurate transfer of a mask pattern without thermally caused dullness of the edge or dross (swell) on the machining surface thanks to minimal generation of heat. This makes laser abrasion advantageous for machining adapted to produce extremely small shapes. In particular, optical functional films produced using a cylindrical die must be machined to produce extremely small shapes of several to several hundreds of micrometers. Therefore, laser abrasion allows such micromachining tasks to be undertaken with ease.

Further, if the resin original plate 9 is machined by laser machining, the resin material irradiated with the laser beam is etched. As a result, the area irradiated with the laser beam is more recessed in a concave form than the area not irradiated therewith. The size of the recess in a concave form can be controlled by using the laser beam irradiation time as a parameter. This makes it possible to create a three-dimensional pattern by irradiating a laser beam onto the machining surface of the resin original plate 9 while changing the opening patterns of the mask 3 in sequence.

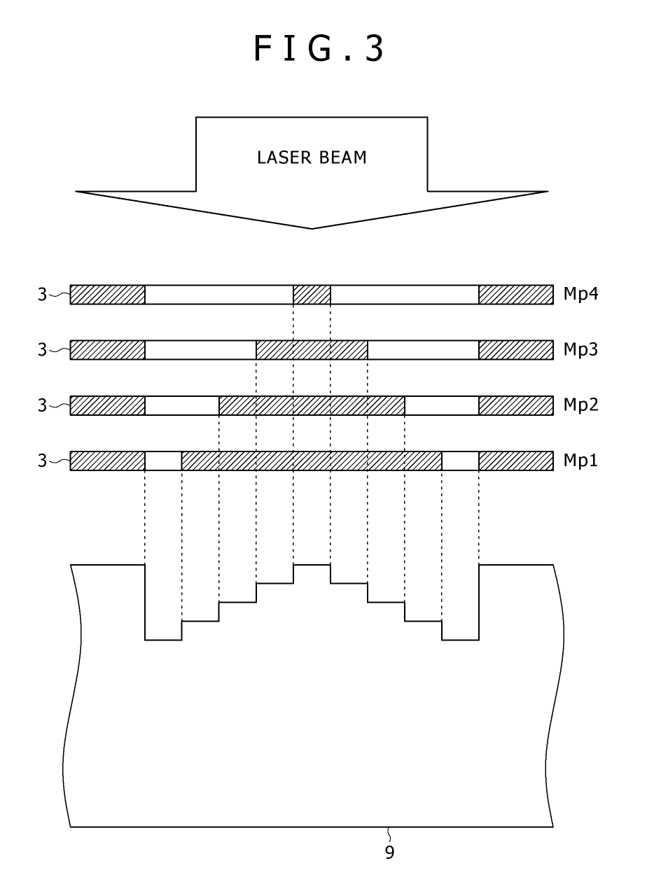

We assume, as an example, that a laser beam is irradiated onto the machining surface of the resin original plate 9 through opening patterns (Mp1, Mp2, Mp3 and Mp4) formed on the mask 3 which are rectangular in plan view, as illustrated in FIG. 3. In this case, a laser beam is irradiated onto the machining surface of the resin original plate 9 through each of the opening patterns a plurality of times while at the same time changing the opening pattern of the mask 3 in sequence from Mp1 to Mp2, to Mp3, and to Mp4. In FIG. 3, the mask 3 is shown to have a plurality of stages for convenience of description. However, the positional relationship (distance) between the machining surface and mask 3 along the optical axis remains the same. This changes the etching depth on the machining surface according to the length of the laser beam irradiation time, thus allowing for a three-dimensional pattern of projections to be formed on the machining surface of the resin original plate 9. Further, if the size difference between the opening patterns can be reduced and if these patterns can be changed a greater number of steps (if the resolution can be increased), it is possible to create a three-dimensional pattern close to a curved surface.

Here, there are mainly two possible schemes for irradiating a laser beam over the entire outer peripheral surface of the resin original plate 9 to suit the desired pattern. The first scheme repeats two operations in sequence, one adapted to rotate the resin original plate 9 one turn using the rotating mechanism 16 while at the same time irradiating the outer peripheral surface of the same plate 9 with the laser beam, and another adapted to inch (linearly and slightly move) the resin original plate 9 in the X direction using the stage 7. In the first scheme, the laser-machined area gradually expands in the direction of the central axis of the resin original plate 9. The second scheme repeats two operations in sequence, one adapted to move the resin original plate 9 in the X direction by the length of the same plate 9 along the central axis using the stage 7, and another adapted to inch (slightly rotate) the resin original plate 9 in the θ direction using the rotating mechanism 16. In the second scheme, the laser-machined area gradually expands in the direction of the circumference of the resin original plate 9. If the second scheme is used, the focal position of the laser beam and other factors must be determined in consideration of the yield in the rotation direction. It is preferred to determine which of the two schemes is to be used in consideration of factors including the shape (three-dimensional shape) of the desired pattern and the effect of debris produced during laser beam irradiation.

Once a pattern is formed on the outer peripheral surface of the resin original plate 9 by laser machining, the resin original plate 9 is detached from the rotating mechanism 16 on the stage 7 to proceed to the next die fabrication process. In the die fabrication process, a die is fabricated by the electroforming method using the resin original plate 9 having a pattern formed thereon in the patterning process. A description will be given next of specific steps of the die fabrication process.

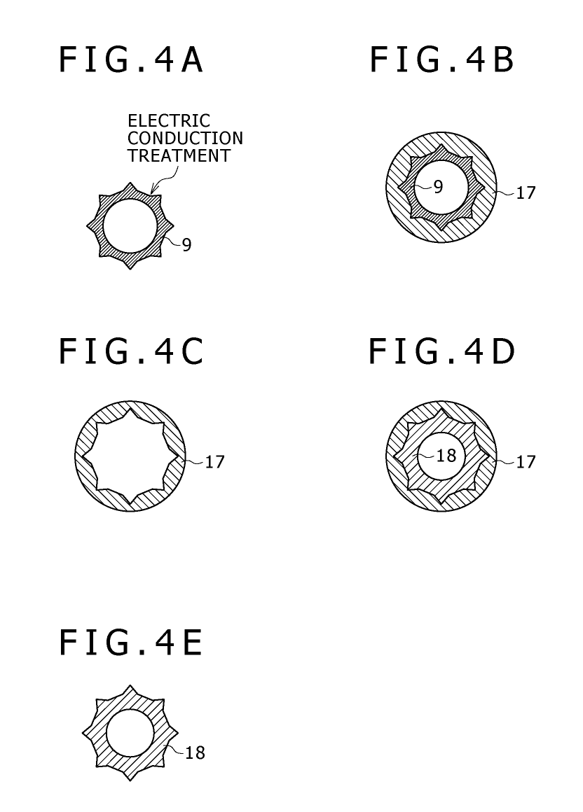

First, as illustrated in FIG. 4A, the resin original plate 9 is subjected to electric conduction treatment. The electric conduction treatment involves forming a conductive film on the surface of the resin original plate 9. Next, as illustrated in FIG. 4B, a first electroforming process is performed using the resin original plate 9, thus causing a metal to be electrodeposited on the outer periphery of the resin original plate 9. This forms a metallic master 17 integrally with the resin original plate 9. The master 17 is formed into a cylindrical shape which is a size larger than the resin original plate 9. Next, as illustrated in FIG. 4C, the resin original plate 9 is destroyed, thus providing the independently structured master 17. In this case, a pattern of projections and depressions inverted from that on the resin original plate 9, is formed on the inner peripheral surface of the master 17. Next, as illustrated in FIG. 4D, a second electroforming process is performed using the master 17, thus causing a metal to be electrodeposited on the inner periphery of the master 17. This forms a die 18 integrally with the master 17. The die 18 is formed into a cylindrical shape which is a size smaller than the master 17. Next, as illustrated in FIG. 4E, the die 18 is pulled out of the master 17. To pull out the die 18, the die 18 is reduced in size by depressurizing the space on the inner peripheral side of the die 18 in the condition shown in FIG. 4D. This provides the independently structured die 18. In this case, the same pattern as that formed on the outer peripheral surface of the resin original plate 9 in the patterning process is formed on the outer peripheral surface of the die 18. For information, the resin original plate 9 would, for example, crack due to lack of strength if the resin original plate 9 was pulled out of the master 17 by depressurizing the space on the inner peripheral side of the resin original plate 9 in the condition shown in FIG. 4B. In order for the master 17 to be structurally independent, therefore, the resin original plate 9 must be destroyed as described earlier.

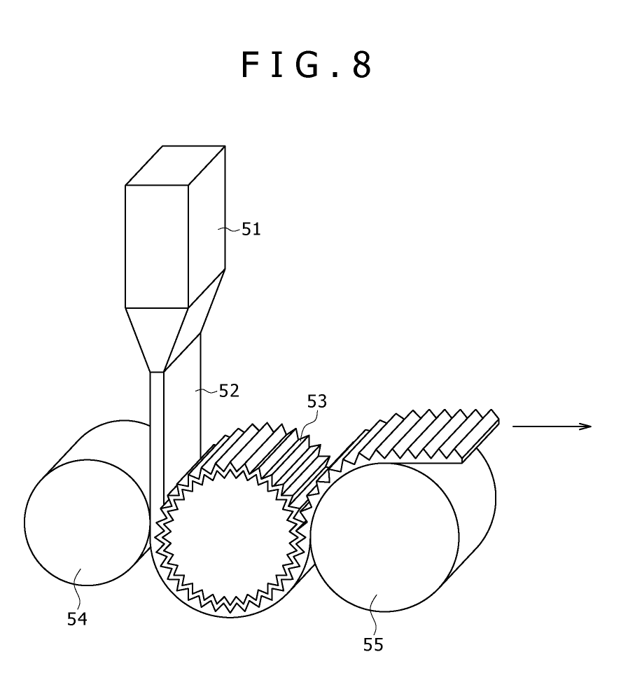

The manufacture of the cylindrical die 18 as described above allows for the formation of a desired pattern with no seam on the outer peripheral surface of the die 18. Therefore, if optical functional films used, for example, for liquid crystal panels are manufactured using the die 18 by the roll-to-roll transfer system (film manufacturing apparatus shown in FIG. 8), the pattern continuity is maintained in the direction of the circumference of the die 18, thus allowing for functional films having optically uniform properties to be continuously manufactured. This makes it possible to handle manufacturing of large size films with the die 18 having a small outer periphery diameter.

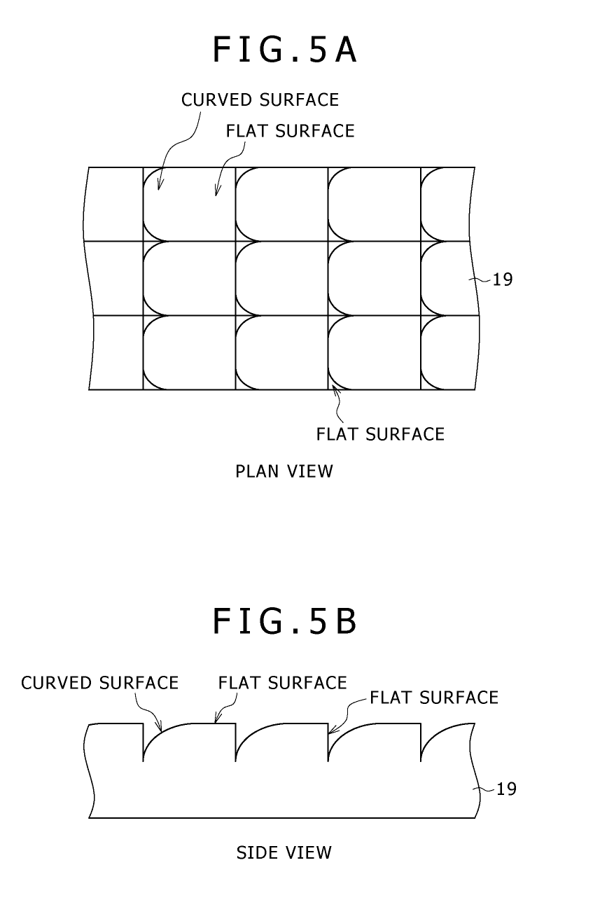

Further, if a cylindrical die is fabricated by machining (e.g., cutting), only linear patterns can be formed. However, if the die 18 is fabricated using the resin original plate 9 having a pattern formed thereon by laser machining, not only linear patterns but also other patterns including curved patterns, patterns combining lines and curves and asymmetrical patterns can be formed on the die 18. On the other hand, photolithography could be another option to form a pattern. This would lead to an increased number of manufacturing process steps, increased capital investment and environmental degradation resulting, for example, from use of chemicals. Laser machining makes it possible to avoid all these problems. Further, abrasion machining permits the etching depth to be controlled based on the integral of energy per time, thus allowing for a free curved surface to be produced. As a result, it is possible to manufacture an optical functional film 19 having a complicated (complex) pattern of projections and depressions combining curved and flat surfaces as illustrated in FIGS. 5A and 5B by using the die obtained by the die manufacturing method of the embodiment of the present invention. This makes it possible to flexibly respond to demand for optical functional films having a variety of optical properties. Further, previously only achievable with a plurality of optical functional films, an optical property can be achieved with less number of or a single optical functional film, thus contributing to reduced device thickness and reduced cost.

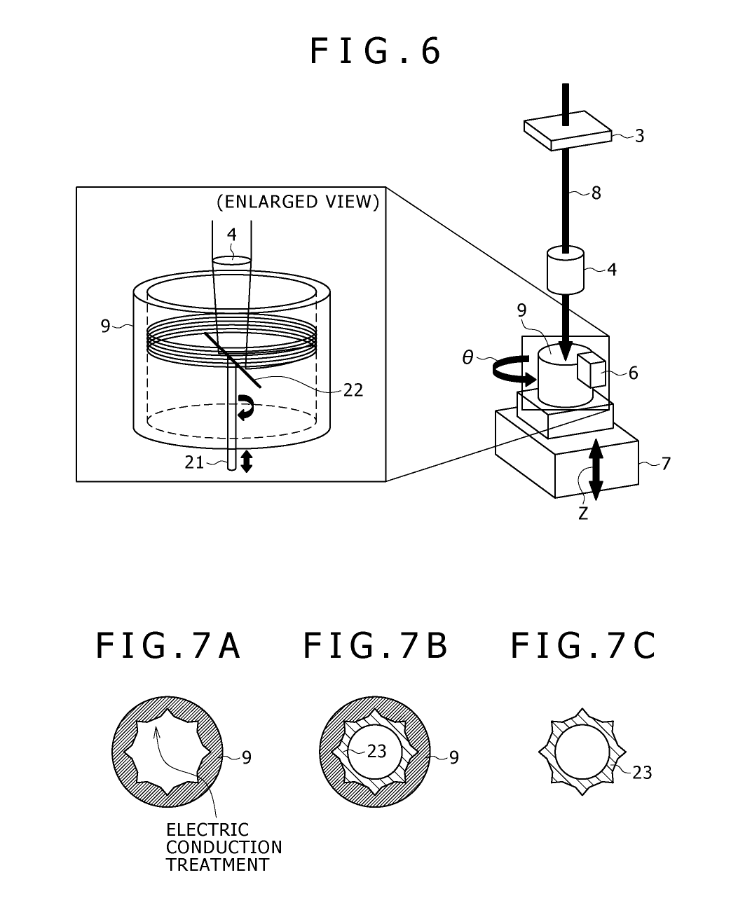

FIG. 6 is a diagrammatic view illustrating another configuration of the laser machining apparatus used for the die manufacturing method according to the embodiment of the present invention. It should be noted that, in FIG. 6 for reasons of convenience, the reflecting mirror 5 is omitted, and the laser optical path 8 is drawn to extend in the vertical direction, with the mask 3 and projection lens 4 shown halfway along the length of the laser optical path 8. Further, functionally like parts of the laser machining apparatus are denoted by the same reference numerals as in FIGS. 1 and 2.

First, with the laser beam from the laser beam source traveling vertically down via the mask 3 and projection lens 4, the cylindrical resin original plate 9 is supported by the rotating mechanism 16 on the stage 7 so that the central axis of the same plate 9 runs along the optical axis of the laser optical path 8. The rotating mechanism 16 is rotated by a precision motor as is done with an air spindle. The same mechanism 16 is provided on the stage 7. The resin original plate 9 is supported by the rotating mechanism 16 so as to be rotatable in the θ direction.

The stage 7 is provided so as to move linearly in the Z direction (vertical direction) along the optical axis of the laser beam. Further, a reflecting mirror 22 is provided on the stage 7. The same mirror 22 is supported by a supporting member 21 in the shape of a rod which stands vertically. The reflecting mirror 22 totally reflects the incident laser beam entering through the projection lens 4 in such a manner as to bend the optical path thereof at a right angle. The same mirror 22 is disposed in the space inside the resin original plate 9 when the same plate 9 is supported by the rotating mechanism 16 on the stage 7 as described earlier. The debris collection mechanism 6 is disposed backward from the bending direction of the laser beam.

In order to form a pattern on the resin original plate 9 in the patterning process using the laser machining apparatus configured as described above, the same plate 9 is placed in position on the stage 7 first. At this time, the resin original plate 9 is positioned on the stage 7 and attached to the rotating mechanism 16 so that the central axis of the cylindrical resin original plate 9 is coaxial with the optical axis of the laser beam and so that the central axis of the same plate 9 is parallel to a travel direction Z of the stage 7.

Next, a laser beam is emitted from the laser beam source. In this case, the laser beam falls on the reflecting mirror 22 through the mask 3 and projection lens 4 and is reflected by the same mirror 22 so as to be bent at a right angle. This causes the laser beam to be irradiated onto the inner peripheral surface (machining surface) of the resin original plate 9. This irradiation of the laser beam forms a pattern of projections and depressions on the inner peripheral surface of the resin original plate 9.

Here, there are mainly two possible schemes for irradiating a laser beam over the entire inner peripheral surface of the resin original plate 9 to suit the desired pattern. The first scheme repeats two operations in sequence, one adapted to rotate the resin original plate 9 one turn using the rotating mechanism 16 while at the same time irradiating the inner peripheral surface of the same plate 9 with the laser beam, and another adapted to inch (linearly and slightly move) the resin original plate 9 in the Z direction using the stage 7. In the first scheme, the laser-machined area gradually expands in the direction of the central axis of the resin original plate 9. The second scheme repeats two operations in sequence, one adapted to move the resin original plate 9 in the Z direction by the length of the same plate 9 along the central axis using the stage 7, and another adapted to inch (slightly rotate) the resin original plate 9 in the θ direction using the rotating mechanism 16. In the second scheme, the laser-machined area gradually expands in the direction of the circumference of the resin original plate 9. It should be noted that although, here, the resin original plate 9 is rotated by the rotating mechanism 16, the supporting member 21 supporting the reflecting mirror 22 may be rotated rather than the resin original plate 9.

Whichever of the two schemes is used, the laser beam irradiation onto the inner peripheral surface of the resin original plate 9 produces debris. Although spouting out vertically from the surface from where the laser beam is irradiated, this debris will fall down by gravity. This makes it unlikely that the debris will deposit on the resin original plate 9, thus providing reduced debris depositing on the resin original plate 9 to be machined.

Once a pattern is formed on the inner peripheral surface of the resin original plate 9 by laser machining, the resin original plate 9 is detached from the rotating mechanism 16 on the stage 7 to proceed to the next die fabrication process. In the die fabrication process, a die is fabricated by the electroforming method using the resin original plate 9 having a pattern formed thereon in the patterning process. A description will be given next of specific steps of the die fabrication process.

First, as illustrated in FIG. 7A, the resin original plate 9 is subjected to electric conduction treatment. Next, electroforming process is performed using the resin original plate 9, thus causing a metal to be electrodeposited on the inner periphery of the resin original plate 9. This forms a die 23 integrally with the resin original plate 9 as illustrated in FIG. 7B. The die 23 is formed into a cylindrical shape which is a size smaller than the resin original plate 9. Next, as illustrated in FIG. 7C, the die 23 is pulled out of the resin original plate 9. To pull out the die 23, the die 23 is reduced in size by depressurizing the space on the inner peripheral side of the die 23. This provides the independently structured die 23. In this case, a pattern of projections and depressions, inverted from that formed on the inner peripheral surface of the resin original plate 9 in the patterning process, is formed on the outer peripheral surface of the die 23.

The manufacture of the cylindrical die 23 as described above allows for the formation of a desired pattern with no seam on the outer peripheral surface of the die 23. Therefore, for the same reasons as described above, it is possible to continuously manufacture functional films having optically uniform properties and handle manufacturing of large size films by means of the die having a small outer periphery diameter. Further, laser abrasion is used to form a pattern on the resin original plate 9. For the same reasons as described above, micromachining tasks can be undertaken with ease, and a free curved surface can be produced.

Still further, it is no longer necessary to destroy the resin original plate 9 in order to fabricate the die 23 in the die fabrication process. This makes it possible to fabricate the plurality of dies 23 by repeatedly using the single resin original plate 9. Still further, because a pattern is formed on the inner peripheral surface of the resin original plate 9, the die 23 can be fabricated by a single electroforming process. This contributes to a reduced number of steps in the die fabrication process.

The functional film according to the embodiment of the present invention is not limited to that having optical functions including polarization, prism, phase difference, optical diffusion, reflection and light collection functions. That is, the present invention is applicable to a functional film having a variety of functions including decoration, thermal insulation, moisture retention, packaging, tactile and visual functions, and to a manufacturing method of the same. Further, although the functional film according to the embodiment of the present invention is properly flexible because the film base material must be wound onto a die before the die pattern is transferred, the film may be rigid and hard after the pattern transfer. Therefore, the functional film obtained from the manufacturing method according to the embodiment of the present invention is not limited to that which is flexible, but may be, for example, a film in the form of a substantially hard plate as a result of hardening by thermal treatment after the pattern transfer.

The present application contains subject matter related to that disclosed in Japanese Priority Patent Application JP 2008-229362 filed with the Japan Patent Office on Sep. 8, 2008, the entire content of which is hereby incorporated by reference.

What is claimed is:

1. A die manufacturing method comprising the steps of:
forming a pattern on the machining surface of a cylindrical resin original plate by laser machining; and
fabricating a cylindrical die by the electroforming method using the resin original plate having the pattern formed.

2. The die manufacturing method of claim 1, wherein
a laser beam having a wavelength in the ultraviolet region is used for the laser machining.

3. The die manufacturing method of claim 1, wherein
a pattern is formed by the laser machining on the outer peripheral surface of the resin original plate.

4. The die manufacturing method of claim 1, wherein
a pattern is formed by the laser machining on the inner peripheral surface of the resin original plate.

5. A functional film manufacturing method comprising the step of
transferring a pattern of a die obtained by a die manufacturing method onto a film base material by using the die, the die manufacturing method including the steps of
forming a pattern on the machining surface of a cylindrical resin original plate by laser machining, and
fabricating a cylindrical die by the electroforming method using the resin original plate having the pattern formed.

6. A functional film obtained by transferring a pattern of a die obtained by a die manufacturing method onto a film base material by using the die, the die manufacturing method comprising the steps of:
forming a pattern on the machining surface of a cylindrical resin original plate by laser machining; and
fabricating a cylindrical die by the electroforming method using the resin original plate having the pattern formed.
